(19) United States
(12) Patent Application Publication
(10) Pub. No.: US 2020/0019907 A1
(43) Pub. Date: Jan. 16, 2020

(54) SYSTEM AND COMPUTER PROGRAM FOR MULTI-PARTY PROJECT SCHEDULE COLLABORATION, SYNCHRONIZATION AND EXECUTION

(71) Applicants: Ranjit Notani, Plano, TX (US); Greg Brady, Dallas, TX (US); Geoffrey Annesley, Stateline, NV (US)

(72) Inventors: Ranjit Notani, Plano, TX (US); Greg Brady, Dallas, TX (US); Geoffrey Annesley, Stateline, NV (US)

(73) Assignee: One Network Enterprises, Inc., Dallas, TX (US)

(21) Appl. No.: 16/034,972

(22) Filed: Jul. 13, 2018

(51) Int. Cl. G06Q 10/06

(52) U.S. Cl. CPC G06Q 10/06313; G06Q 10/063116

(57) ABSTRACT

Accordingly, one aspect of the present invention is to provide a system for multi-party project schedule collaboration, synchronization and execution in mega project operations across project and supporting supply chain networks. The system includes a plurality of remote computers in communication with a respective plurality of entities, a central server provided by a service provider over a network, a network interface in communication with the central server and the plurality of remote computers over a network, and a shared database in communication with the central server. The network interface being configured to receive one or more schedule updates via the network. The shared database a shared schedule having inter-shared relationships, one or more schedule tasks, a plurality of portions of the shared schedule and an execution plan to execute the shared schedule. Each of the one or more schedule updates includes a plurality of planned events impacting one or more of the plurality of portions. One or more of the plurality of portions being shared by at least two of the plurality of entities. The central server is configured to receive a schedule update from at least one of the plurality of entities in the supply chain network, update a first portion of the plurality of portions, compute and update a portion of the execution plan based on the updates to the first and second portions, wherein the update does not change the entirety of the execution plan, and notify the affected entities of the plurality of entities regarding the revised execution plan. The update results in a second portion of the plurality of portions also being updated. The one or more schedule updates are propagated to the supply chain network and the plurality of planned events and their respective timing are utilized to update the one or more schedule tasks.

### BACKGROUND OF THE INVENTION

### Field of the Invention

The present invention is generally related to improved database and network processing, and more particularly to a system and computer program for multi-party project schedule collaboration, synchronization and execution.

### Discussion of the Background

Large complex projects, such as mega construction projects, and their supporting supply chains are characterized by a high degree of collaboration, cooperation, and interdependency between the enterprise and other entities or partners such as contractors, sub-contractors, inspection and compliance agencies, resource, labor, material suppliers and the like. The business goal of managing and optimizing both mega project operations in conjunction with connected and supporting supply chains is to minimize project delays, minimize project risks, as well as the costs incurred by all participants while meeting service level agreements, project milestones, compliance requirements and maximizing profits.

A typical mega project and the supporting supply chains span multiple companies and/or entities and sometimes include hundreds or even thousands of companies and/or entities. Each company and/or entity typically maintains its own separate schedules and separate supply chain planning and execution systems. In particular, each company and/or entity maintains its own project schedules and supply chain networks locally on its own computer systems, databases and computer programs associated with the project and supporting supply chain network. In systems known in the prior art, each company and/or entity maintained its own multi-tier or multi-echelon system and schedules. The companies would then typically communicate with other companies in the network via exchange messages (typically EDI), email, fax and phone calls. These techniques are inherently flawed which affects project risk, deliverables and economic performance.

Due to the high degree of coupling in the prior art, any changes in schedules resulted in extensive modifications throughout the project networks and supporting supply chains. Due to the size and complexity of most mega projects and supporting supply chains, the prior art often resulted in stale or out of date schedules being used as well as discord across supporting supply chains. It is also difficult if not impossible to deploy new multi-company processes using the techniques known in the prior art.

Thus, there currently exist deficiencies associated with multi-party schedule coordination, synchronization, and, in particular, with a system and computer program for multi-party project schedule collaboration, synchronization and execution and synchronization of supporting supply chains.

### SUMMARY OF THE INVENTION

Accordingly, one aspect of the present invention is to provide a system for multi-party project schedule collaboration, synchronization and execution in mega project operations across project and supporting supply chain networks. The system includes a plurality of remote computers in communication with a respective plurality of entities, a central server provided by a service provider over a network, a network interface in communication with the central server and the plurality of remote computers over a network, and a shared database in communication with the central server. The network interface being configured to receive one or more schedule updates via the network. The shared database includes a shared schedule having inter-schedule relationships, one or more schedule tasks, a plurality of portions of the shared schedule and an execution plan to execute the shared schedule. One or more of the plurality of portions being shared by at least two of the plurality of project or entities. Each of the one or more schedule updates includes a plurality of planned events impacting one or more of the plurality of portions. The central server is configured to receive a schedule update from at least one of the plurality of project or entities in the project and supply chain network, update a first portion of the plurality of portions, compute and update a portion of the execution plan based on the updates to the first and second portions, wherein the update does not change the entirety of the execution plan, and notify the affected entities of the plurality of project and entities regarding the revised execution plan. The update results in a second portion of the plurality of portions also being updated. The one or more schedule updates are propagated to the supply chain network and the plurality of planned events and their respective timing are utilized to update the one or more schedule tasks.

According to one embodiment, synchronization of dependencies between schedules are maintained by different organizations and project scheduling tools. Synchronization of dependencies between multiple schedules maintained by different organizations and any number of supporting multi enterprise supply chain networks. Change collaboration between organizations across multiple schedules maintained by different project scheduling tools. Visibility into impact that changes on one schedule have on other schedules maintained on different organizations on separate networks and by different types of tools. Visibility into the impact that supply chain changes have on any number of connected schedules. Finally, detection of critical path between schedules created and maintained by different organizations and project scheduling tools.

### BRIEF DESCRIPTION OF THE DRAWINGS

A more complete appreciation of the present invention and many of the attendant advantages thereof will be readily obtained as the same becomes better understood by reference to the following detailed description when considered in conjunction with the accompanying drawings, wherein:

FIGS. 1A-1G are block diagrams illustrating a system and computer program for multi-party schedule collaboration, synchronization and execution in accordance with an embodiment of the present invention; and

FIGS. 2A-2B are flow charts illustrating a system and computer program for multi-party schedule collaboration, synchronization and execution in accordance with an embodiment of the present invention.

### DETAILED DESCRIPTION OF THE PREFERRED EMBODIMENTS

Referring now to the drawings, wherein like reference numerals designate identical or corresponding parts throughout the several views, preferred embodiments of the present invention are described.

The present invention relates to coordinating and synchronizing project and supply chain execution across decentralized networks of organizations, teams, resources and people. As a non-limiting example, the construction industry is provided to define and refine use cases, user interfaces and schedule collaboration protocols. However, it is understood that the present invention may be used with respect to any decentralized networks of organizations, teams, resources and people.

Although numerous project management tools and mobile applications exist in the prior art, these prior art solutions are not appropriate for large complex projects involving many parties in which one or more schedules and connected supply chain networks may be created and referenced by different project scheduling tools which may be independently maintained and controlled by different parties. Projects and the teams executing schedules on sites are often impacted by events, deliveries and other milestones that are not captured or updated and reflected on schedules in time for teams to respond effectively. Real-world realities and fast changing conditions are hard to reflect in schedules especially when schedules maintained by different tools and organizations have dependencies. This results in missed handoffs between project actors and actors or agents bypassing channels of communication and schedules which are often not synchronized and out of date with the current real-world situation. Current systems and models are therefore not effective for tactical execution on complex projects such as large construction projects. Schedules are relegated to being used primarily for reference as longer term coordination tools and for reporting rather than for the efficient execution of site tasks.

Large projects involving many parties typically include different project schedules generated by different applications, maintained by different groups across different business units and companies. There are master schedules, field schedules, sub-schedules, supplier schedules, site operation schedules, procurement schedules, material and resource delivery schedules. Schedules are impacted by unexpected delays, unexpected conditions, failures, quality issues, labor issues, inspection delays, permit delays, resource availability, and the like. Task and site team execution is impacted by real-time site and supply chain conditions that are often not reflected accurately across all the schedules due to a lack of connectivity and automated change propagation between schedules maintained in siloed and centralized project management tools.

The present invention provides a solution to realize short term execution efficiencies and enable coordination, time, resource utilization and cost savings on large complex fast changing construction site projects involving multiple parties. Significant efficiency improvements are realized by all parties involved in large multi-party construction site projects using the present invention. Such improvements include (i) automated propagation of changes between related schedules and sub-schedules and supporting supply chains with real-time visibility for all parties across any number of schedules to task completion status, delays, issues, alerts, change requests; (ii) site driven task updates across any number of schedules via an online mobile application; (iii) consolidated dispatch of tasks to site personal across any number of project schedules; (iv) visibility of supply chain logistics milestones (such as, site delivery times, delay durations, delay reasons, and the like) enabling better site coordination and task and resource adjustments management; (v) notification of supply, equipment site receipts, quality inspection results, asset locations and usage or consumption allocation status; (vi) visibility of procurement milestones (supply ETA to site, supplier collaboration, and the like) enabling better site coordination, task and resource adjustment management; and (vii) visibility into tactical changes of resource availability, labor availability, supply availability, permits, and the like. Using the present invention, site teams can coordinate and collaborate more effectively to execute site activities with more efficiency thereby reducing project delays, saving time and cost.

### I. Multi-Party Schedule Collaboration

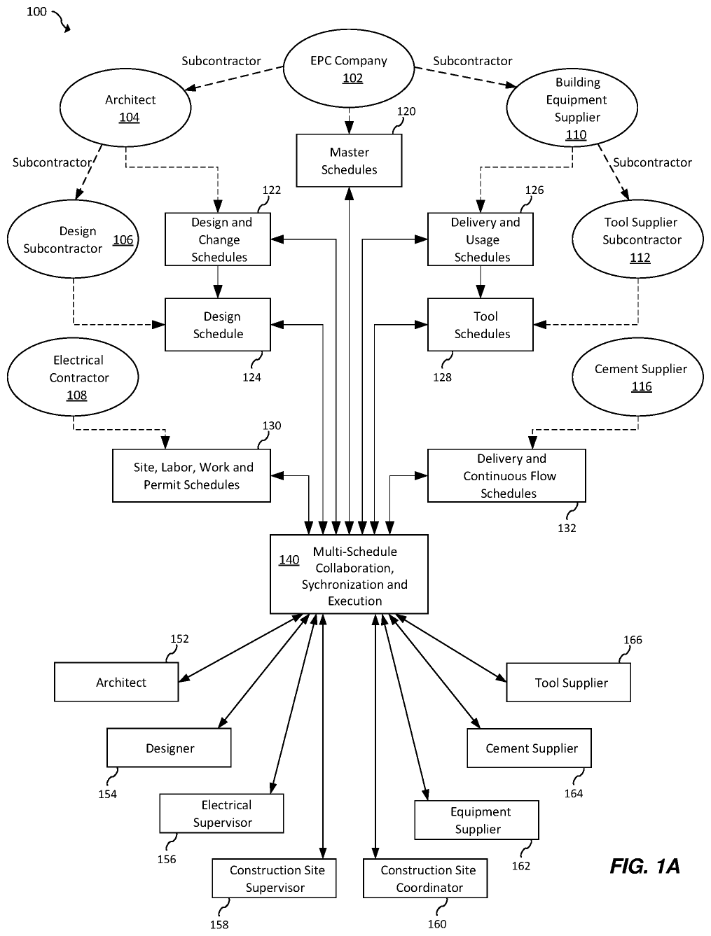

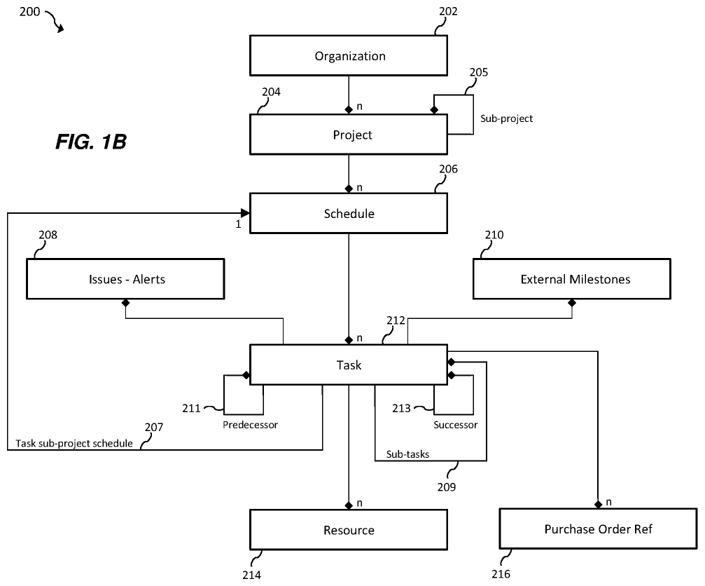

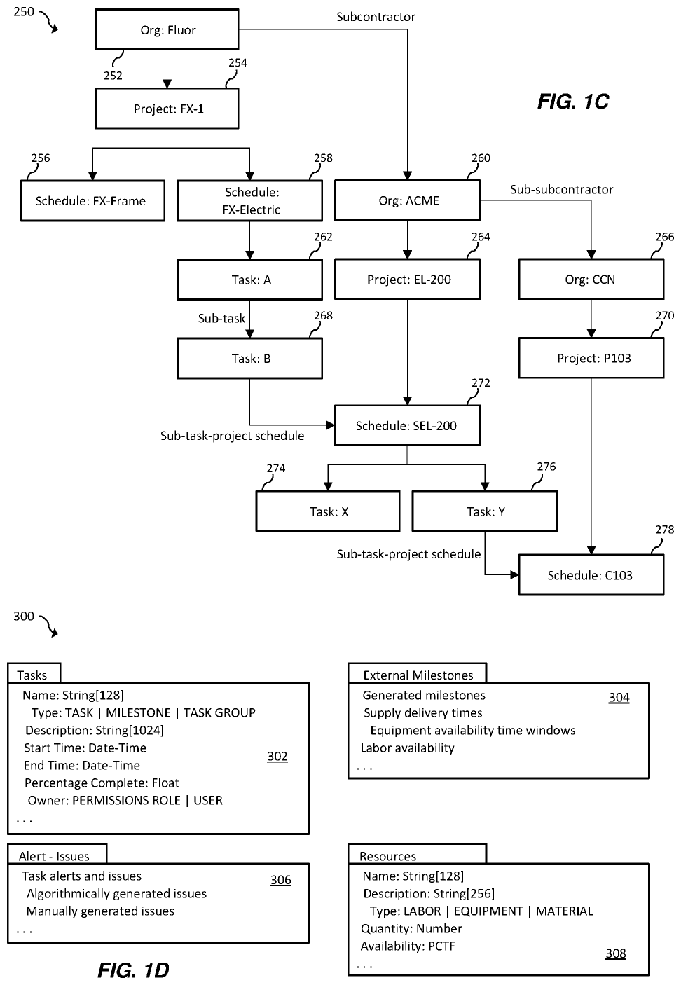

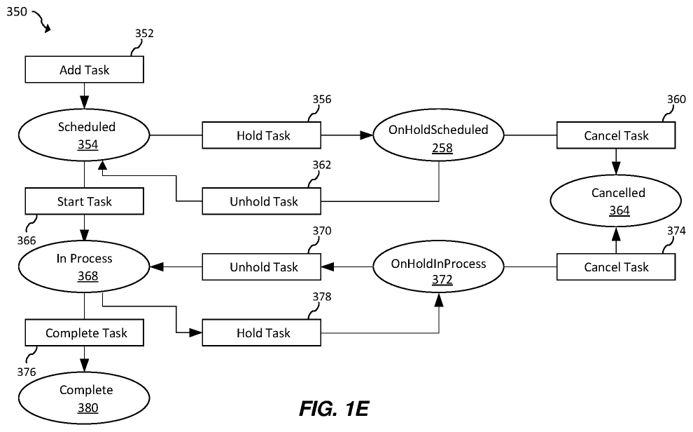

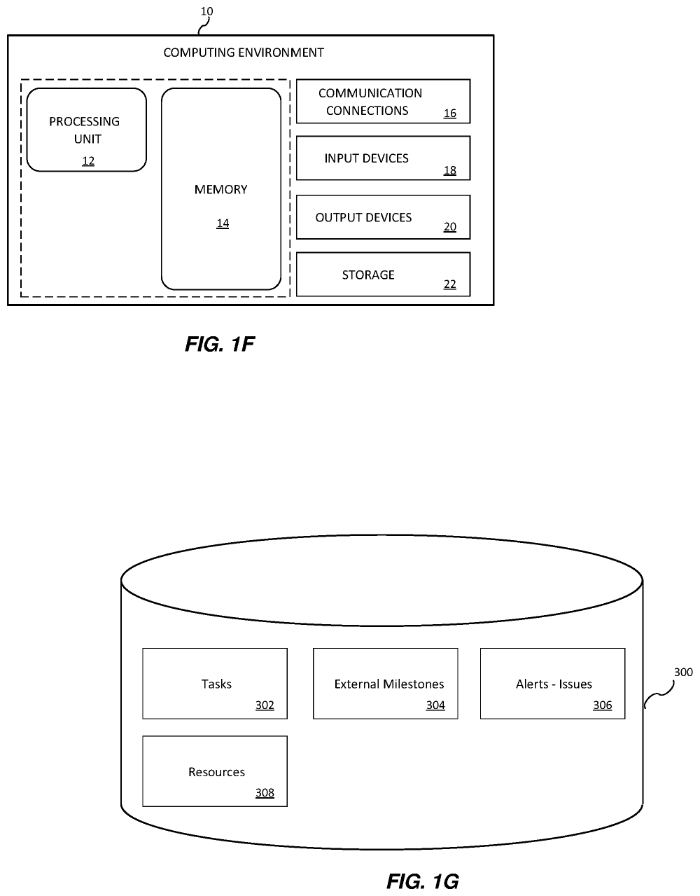

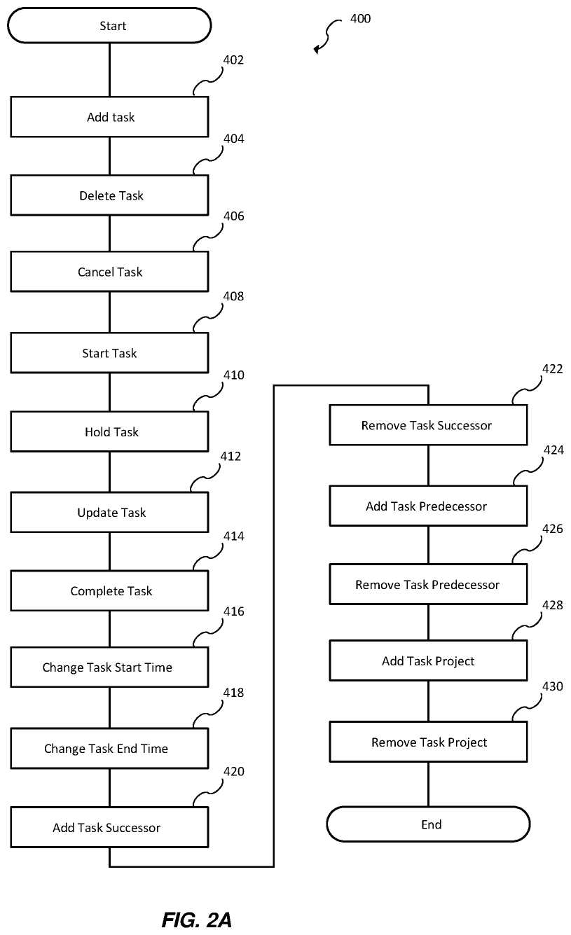

Referring to FIG. 1A, a block diagram illustrating a system and computer program for multi-party schedule collaboration, synchronization and execution in accordance with an embodiment of the present invention, is shown. According to this embodiment, schedules mastered by different systems and by different organizations may be communicated to a central server provided by a service provider over a network using standard project schedule inbound and outbound interfaces. As shown, the schedules mastered by different systems and by different organizations include, without limitation, master schedules 120, design and change schedules 122, design schedule 124, delivery and usage schedules 126, tool schedules 128, site, labor, work and permit schedules 130, delivery and continuous flow schedules 132, and the like. Different organizations include, without limitation, EPC company 102, architect 104, design subcontractor 106, electrical contractor 108, building equipment supplier 110, tool supplier subcontractor 112 and cement supplier 116, and the like. It is understood that although the exemplary organizations shown are within the construction industry, that the present invention may be used with respect to any decentralized networks of organizations, teams, resources and people.

Outbound interfaces of a multi-schedule collaboration, synchronization and execution engine 140 are utilized to update external project schedules with changes initiated by project schedule changes, supply chain changes, site or mobile users. Inbound interfaces of the multi-schedule collaboration, synchronization and execution engine 140 are utilized to synchronize changes from project scheduling tools outside of the service provider network to mobile and site users. Remote users view, update or request changes to multiple schedules based on assigned role/permissions. Remote users may access the system of the present invention using, without limitation, portable computer, mobile devices, tablets and the like. Schedules that are linked across multiple parties are synchronized by back propagating timing and task constraints across the network as well as up and down schedule/sub-schedule hierarchies. Remote users include, without limitation, architect 152, developer 154, electrical supervisor 156, construction site supervisor 158, construction site coordinator 160, equipment supplier 162, cement supplier 164, tool supplier 166, and the like.

### Mobile Schedule and Task Views

According to the present invention, mobile users are presented with graphical user interfaces which allow remote users to view and manage, without limitation: (i) task start period (such as, a day interval, a week interval, a month interval and the like); (ii) task end period (such as, a day interval, a week interval, a month interval and the like); (iii) organization, project, site, resources, task type, task status, critical path tasks, and time window filtering; (iv) upstream and downstream task and milestone dependencies across organizations; (v) view types.

Task and site project owners should be labeled to allow easy cross team collaboration. View types include (i) a simple flat task list sorted by start time or end time or task type; (ii) an alert view showing late tasks, upstream task delays (start and completion time delays); (iii) resources by task—flat list; (iv) a Gantt view—tasks, task status, owner and milestones displayed on a time line view; (v) geographic view—view task and resource location overlay on google maps. According to one embodiment, a remote user's GPS map coordinate may be provided on a map if the remote user is within the perimeter of a predefined map boundary.

### Mobile Schedule and Task Notifications

According to one embodiment, users are notified, via a mobile application, and prompted to respond to: (i) task change notifications sent to owners of downstream (successor) tasks; (ii) task advanced completion notifications (TaskAdvancedCompletionNotification or “TACN”) sent to downstream task owners when an upstream predecessor task is completes a configurable near completion threshold defined as a percent or remaining time to complete (such as one day, two days, and the like); (iii) tasks projected to be late with respect to the current planned completion time, based on a configurable late threshold; (iv) tasks that could start earlier than planned; (v) changes to required task resources (such as labor, equipment, material and the like); (vi) stale tasks that require status updates; (vii) upstream and downstream task changes that impact viewers tasks and area of responsibility; (viii) milestone changes that impact a user's (or users team) tasks; (ix) recommendations for mitigation of time delays and cost overruns; (x) task comments and notices logged by other mobile users that may impact a user's tasks and area of responsibility; (xi) supply, equipment, resource, labor and material availability changes (via milestones) and issues; and (xii) contact information of task and project owners to enable efficient collaboration.

### Mobile Schedule and Task Actions

According to one embodiment, mobile users can perform the following tasks based on their permissions: (i) update task completion status; (ii) extend task completion times; (iii) request task start time change; (iv) add new tasks and required resources; (v) add or remove task dependencies—predecessor and successor relationships within and across project schedules; (vi) view impact of task completion delays (before task time changes are committed) on other tasks, teams and overall project timing; (vii) view delivery times of suppliers, equipment, and the like that may impact the execution of the tasks they are responsible for; (viii) raise alerts and issues and associated alerts/issues with tasks, milestones or resources; and (ix) view, search and filter tasks (by type, resource, time window) across multiple schedules in one view.

### II. Multi-Party Multi-Tier Schedule Data Model

Referring to FIG. 1B, a block diagram illustrating a schedule data model design representing multiple schedules generated by different schedule systems authored and maintained by different organizations in accordance with an embodiment of the present invention, is shown. According to this embodiment, predecessor links 211 and successor links 213 can span different schedules 206 and projects 204. A task 212 can refer to another schedule 206 maintained by other tools and organizations via link 207.

### Multi-Tier Propagation of Schedule Time Changes Across Organizations and Project Tools

Project schedules are typically updated in isolation by isolated scheduling tools and often by different organizations. This causes discord between project teams, manual effort to synchronize across projects and less than optimal site execution performance.

The system of the present invention propagates time changes at the project level into the parent tasks that refer to other schedules. This will automatically synchronize timing across project schedules, schedule—sub schedule hierarchies, tasks and organizations as well as supporting project supply chains.

Referring to FIG. 1C, a block diagram illustrating an exemplary multi-party tier schedule data model in accordance with an embodiment of the present invention, is shown. Assuming that task X 274 will take two days, task Y 276 will take three days, and that task Y 276 begins after task X 274 completes. Schedule SEL-200 time duration is calculated as 2 days+3 days=5 days. Given that task B 268 in schedule FX-Electric 258 refers to the Project EL-200 264, then the present invention will keep the duration and start/end time of task B 268 equal to the overall duration and start/end time of schedule SEL-200 264. According to the present embodiment, the multi-tier schedule synchronization of the present invention facilitates management of individual organization schedules using that entity's own tools and processes but at the same time the interdependent timing changes between projects is automatically propagated across all relevant schedules and organizations.

The present invention utilizes a database to store data. For example, a block diagram illustrating exemplary tables with commentary and notable fields in accordance with an embodiment of the present invention, is shown in FIGS. 1D and 1G. According to this non-limiting example, the database includes a task table 302, an external milestones table 304, an alerts or issues table 306, a resource table 308, and the like. However, it is understood that other tables may be utilized within the scope of the present invention.

### Geographic Visibility

According to at least one embodiment, remote users are provided a graphical user interface to optionally tag geographic location information (such as, for instance, address, GPS coordinates, and the like) to tasks and resources. Large construction sites may have assets and supplies scattered across warehouses, inspection areas, temporary storage locations and the like. Using this capability of the present embodiment, site managers and workers may easily gather at task execute locations and locate equipment/materials required to execute work associated with their assigned tasks.

### Decentralized Collaboration & Execution

As is known in the industry, schedule status, enabled by current market solutions, is typically maintained by centralized project management teams and scheduling tools that provide project managers the ability to add tasks, change task timing, resource requirements, and the like. Project managers gather information from project teams and update schedules. Change coordination between different companies and associated schedules are done manually and ad hoc requiring high manual effort. Schedule accuracy of interdependent schedules maintained by different project tools, business units and companies is often materially not accurate with respect to real project, site and supply chain status and conditions. This current systems and models are slow, time consuming and do not allow for fast efficient change management between teams that are operating on different schedules, and different organizations, nor does it allow for site managers that are accountable for site deliverables to collaborate effectively with other site teams with project and task interdependencies. This legacy model does not effectively leverage the insights that project managers, team leads and site workers could apply to adapt to unpredicted events, upstream task delays, mitigate delay impact, work around resource and labor availability, material availability, et cetera.

The present invention improves schedule accuracy and aligns supply chain plans across any number of schedules and improves site execution performance using a decentralized collaboration protocol to enable decentralized tactical decision making by those that are accountable for site execution to reduce time delays and optimize resource usage. Schedule representations are maintained on the network platform and synchronization is performed via an algorithm that propagates schedule changes between any number of schedules on the network as well as up and down schedule—sub-schedule hierarchies. Each schedule instance can update the project management tools via interfaces defined by 3rd party project tools. By enabling teams across business units and different organizations to collaborate at the task level across schedules maintained by different organizations and tools, construction sites and other types of projects are enabled to operate as loosely coupled by efficient “holarchies”.

### Task State Management

Task lifecycles are managed by states and transactions that may initiate state transitions. A set of baseline transactions and state graph is defined here. The states and transactions can be extended and changed to tailor capabilities as needed via the service provider's public APIs and ONE Network's DevNET tools.

### Task Modification Transactions

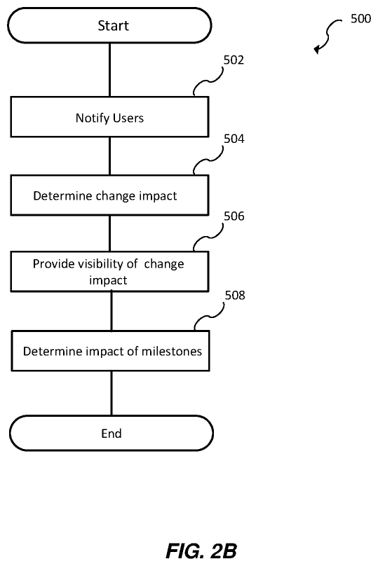

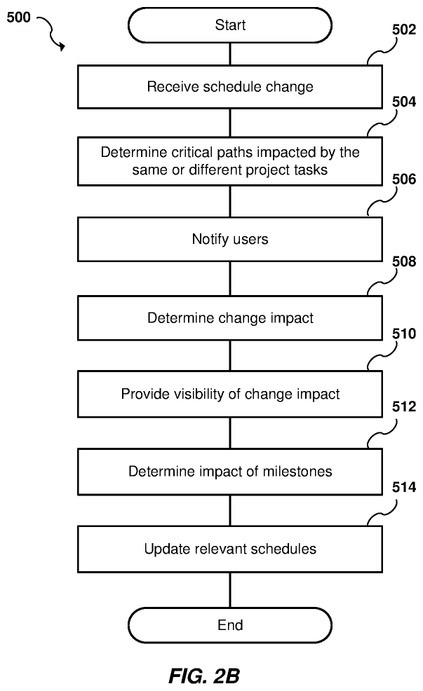

Referring to FIG. 1E, a block diagram illustrating task state workflow and transactions in accordance with an embodiment of the present invention, is shown. Task transactions can be issued from any device or algorithm. Task transactions are processed in time order. Exemplary task modification transactions utilized by the present invention are shown in FIG. 2A and include, without limitation, AddTask 402, DeleteTask 404, CancelTask 406, StartTask 408, HoldTask 410, UpdateTask 412, CompleteTask 414, ChangeTaskStartTime 416, ChangeTaskEndTime 418, AddTaskSuccessor 420, RemoveTaskSuccessor 422, AddTaskPredecessor 424, RemoveTaskPredecessor 426, AddTaskProject 428, RemoveTaskProject 430, and the like. These exemplary task modification transactions are described in table 1 below.

TABLE 1

| Task Transaction | Description |
|---|---|
| AddTask | Adds a task to the target schedule instance |
| DeleteTask | Removes an existing task from the target schedule instance |
| CancelTask | Cancels the task but the task remains on the schedule instance. The |
| | task is moved to the HOLD or CANCELED state |
| StartTask | Moves the task to the “RUNNING” or “OPEN” state and loads any |
| | assigned resources required for this task |
| HoldTask | Puts the task into the “ON HOLD” or “HOLD” state and frees |
| | allocated resources from this task |
| UpdateTask | Updates any attribute of the task via name/value pair definitions |
| CompleteTask | Moves the task to the “COMPLETE” or “FINISHED” state |
| ChangeTaskStartTime | Defines or modifies the task start time mm/dd/yyyy hh:mm:ss |
| ChangeTaskEndTime | Defines or modifies the task end time mm/dd/yyyy hh:mm:ss |
| AddTaskSuccessor | Adds a successor relationship between tasks |
| RemoveTaskSuccessor | Removes a successor relationship between tasks |
| AddTaskPredecessor | Adds a task predecessor connection between tasks |
| RemoveTaskPredecessor | Removes a task predecessor connection between tasks |
| AddTaskProject | Adds a task-sub-project reference to another project; the project |
| | start/end time defines the timing for the parent task pointing to the |
| | project |
| RemoveTaskProject | Delete a task-sub-project reference between a task and the |
| | connected project schedule |

### Milestone Modification Transactions

Milestones are used to represent logistics, procurement and quality events that can impact task start and completion times. Milestones are generated by systems outside of scheduling tools such as logistics planning and execution systems or supply chain, procurement and design systems. Frequent and near real-time updates of milestones integrated with schedules is an important dimension to enable efficient site execution and response to delays (or early delivery/availability) of material, equipment, tools, and other resources required to execute site jobs. Exemplary milestone modification transactions utilized by the present invention are shown in Table 2 below.

TABLE 2

| Task Transaction | Description |
|---|---|
| AddMilestone | Adds a milestone object to the target schedule |
| RemoveMilestone | Removes a milestone object from the target schedule |
| ChangeMilestoneTime | Changes the milestone time: mm:dd:yyyy hh:mm:ss |
| AddMilestoneTaskSuccessor | Creates a milestone task successor relationship |
| AddMilestoneTaskPredecessor | Creates a milestone task successor relationship |
| RemoveMilestoneTaskSuccessor | Deletes a milestone task successor relationship |
| RemoveMilestoneTaskPredecessor | Deletes a milestone task successor relationship |

### Task Collaboration Transactions

Collaboration transactions are used to facilitate change requests between teams and organizations across and within schedules and organizations. Exemplary collaboration transactions utilized by the present invention are shown in Table 3 below.

TABLE 3

| Task Transaction | Description |
|---|---|
| RequestTaskStartTimeChange | Creates a change request for changing a task start time |
| | on a target schedule |
| CommitToTaskStartTimeChange | Approves and Commits a change request for a task |
| | start time change; note the commit time may not equal |
| | the request time |
| RequestTaskEndTimeChange | Creates a change request for changing a task end time |
| | on a target schedule |
| CommitToTaskEndTimeChange | Approves and Commits a change request for a task end |
| | time change; note the commit time may not equal the |
| | request time |
| RequestResourceChange | Change resource quantity, resource type, resource |
| | utilization on the target task and schedule |
| CommitResourceChange | Approve and commit resource change request with the |
| | same or different resources as requested in the |
| | RequestResourceChange transaction. |
| HoldTask | Hold or remove hold on task with reason code |
| CancelTask | Task is no longer required to be completed or started |
| TaskAdvancedCompletionNotification | Notification sent to downstream task owners when an |
| (TACN) | upstream predecessor task is near completion |
| ConnectTaskToSchedule | Connects a parent task in one schedule to a separate |
| | schedule; the parent task start time is defined by the |
| | task start time of the first task in the connected |
| | schedule; the parent task end time is defined by the |
| | task end time of the last task in the connected schedule |
| DisconnectTaskFromSchedule | Removes the relationship between a parent task in one |
| | schedule and another schedule |
| ConnectTaskToScheduleTask | Connects a task in one schedule (source schedule) to a |
| | task in another schedule (target schedule); successor |
| | or predecessor relationship can be defined by this |
| | message as well as time offset from the start or end of |
| | the task in the target schedule. |
| DisconnectTaskFromScheduleTask | Removes a relationship (connection) between a task in |
| | the source schedule and a task in the target schedule |

### Resource Tracking

Resources are also sometimes referred to herein as “assets.” According to one embodiment, resources which are required to execute tasks should be visible to task owners. Resource status, locations, projected availability should be tracked and visible. Exemplary transactions utilized by the present invention to update resource status are shown in Table 4 below. Without limitation, these transactions may be performed from a mobile device, such as a cell phone, tablet, PDA, laptop, and the like.

TABLE 4

| Resource Tracking | Description |
|---|---|
| SetAssetLocation | Uses the current GPS location of the transaction |
| | initiator to update the asset/resource location. Or |
| | scanning of a QR code, BAR code or RFID can |
| | also be used |
| ViewAssetLocation | Displays the asset on a map and the last location |
| | update time. If the asset is in transit the map |
| | shows current and destination locations along |
| | with transport times |

### Multi Schedule Critical Path Detection

Critical path detection is performed by analyzing task dependencies and timing to determine which tasks must be completed on time to avoid a delay in overall project completion time. Single schedule critical path detection is available in most project management and scheduling tools. According to one embodiment, the critical path is detected across tasks contained in different schedules. This is referred to herein as “multi-schedule critical path detection”. Referring to FIG. 2B, a flow chart illustrating a multi-schedule critical path detection in accordance with an embodiment of the present invention, is shown. At block 502, a schedule change is received. Critical paths impacted by the same or different project tasks are determined, at block 504. At block 506, users across projects are notified when their tasks are on the critical path and impacted by the same or different project tasks. The impact the changes (task duration change, task resource change, task dependency change, new task, task completed, task cancellation) are determined at block 508. Users are provided what impact the changes will have on other tasks, and critical path dimensions such as project and sub-project completion dates, at block 510. At block 512, the impact of milestones (site equipment and material delivery times, resource availability times, and the like) will also be considered when calculating critical paths across schedules. The relevant schedules are updated, at block 514.

Remote users, such as without limitation mobile users, can link tasks together across different projects by creating predecessor and successor relationships. Often these interdependencies are not fixed nor clearly defined at the master schedule level. This capability allows site workers to quickly link and unlink tasks, subject to permissions, in the same schedule or between schedules as conditions change on site. The critical path detection algorithm can be run periodically or on demand to allow what if capability to understand impacts of task changes before they are committed to. Note it will be normal for many fractured critical paths to be detected by the algorithm. This use case is to be considered for elegant user notification and change impact analysis.

### Automated Task Dependency Detection

According to one embodiment, task dependencies are detected between schedules to improve project completion prediction and allow for improving mitigation measures. Possible techniques to detect task dependencies include without limitation: (i) simple detection of end and start time equality between tasks; (ii) inference via machine learning algorithms driven by past project execution sequencing and timing; and (iii) resource utilization across tasks, which is useful if infinite capacity scheduling is used to generate schedules.

The present invention may utilize or more computer applications. As used herein, a “computer application” is a computer executable software application of any type that executes processing instructions on a computer or embedded in a processor, and an “application” or “application project” are the files, objects, structures, database resources and other resources used in integrating a computer application into a software platform.

While the present invention has been described with reference to one or more particular embodiments, those skilled in the art will recognize that many changes may be made thereto without departing from the spirit and scope of the present invention. Each of these embodiments and obvious variations thereof is contemplated as falling within the spirit and scope of the claimed invention, which is set forth in the following claims.

This invention may be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As will be appreciated by one of skill in the art, portions of the invention may be embodied as a method, device, or computer program product. Accordingly, portions of the present invention may take the form of an entirely hardware embodiment or an embodiment combining software and hardware aspects all generally referred to as a “circuit” or “module.”

As shown in FIG. 1F, the present invention includes a computer program product which may be hosted on a computer-usable storage medium 14 having computer-usable program code embodied in the medium and includes instructions which perform the processes set forth in the present specification on a processing unit 12. The storage medium 14 may include, but is not limited to, any type of disk including floppy disks, optical disks, CD-ROMs, magneto-optical disks, ROMs, RAMs, EPROMs, EEPROMs, flash memory, magnetic or optical cards, or any type of media suitable for storing electronic instructions. The computing environment may also include, without limitation, communication connections 16, input devices 18, output devices 20 and storage 22.

Computer program code for carrying out operations of the present invention may be written in any programming language including without limitation, object oriented programming languages such as Java®, Smalltalk, C # or C++, conventional procedural programming languages such as the “C” programming language, visually oriented programming environments such as VisualBasic, and the like.

Obviously, many other modifications and variations of the present invention are possible in light of the above teachings. The specific embodiments discussed herein are merely illustrative, and are not meant to limit the scope of the present invention in any manner. It is therefore to be understood that within the scope of the disclosed concept, the invention may be practiced otherwise then as specifically described.

1. A system for multi-party project schedule collaboration, synchronization and execution in mega project operations across project and supporting supply chain networks, the system comprising:
a plurality of remote computers in communication with a respective plurality of entities;
a central server provided by a service provider over a network;
a shared database in communication with the central server, wherein the shared database includes a shared schedule having inter-shared relationships, one or more schedule tasks, a plurality of portions of the shared schedule and an execution plan to execute the shared schedule, one or more of the plurality of portions being shared by at least two of the plurality of entities;
a network interface in communication with the central server and the plurality of remote computers over a network, the network interface being configured to receive one or more schedule updates via the network, wherein each of the one or more schedules updates includes a plurality of planned events impacting one or more of the plurality of portions; and
wherein the central server is configured to:
receive a schedule update from at least one of the plurality of entities;
update a first portion of the plurality of portions, wherein the update results in a second portion of the plurality of portions being simultaneously updated;
compute and update a portion of the execution plan based on the updates to the first and second portions, wherein the update does not change the entirety of the execution plan, the one or more schedule updates are propagated to the supply chain network and the plurality of planned events and their respective timing are utilized to update the one or more schedule tasks; and
notify the affected entities of the plurality of entities regarding the revised execution plan

2. The system of claim 1, wherein schedule update adds an additional task to the plurality of planned events.

3. The system of claim 1, wherein the plurality of entities comprise supply chain entities.

4. The system of claim 1, wherein the plurality of entities comprise project entities.

5. The system of claim 1, wherein the respective plurality of portions of the shared schedule are maintained by different entities of the plurality of entities using different project scheduling tools.

6. The system of claim 1, wherein collaboration between the plurality of entities across respective plurality of portions of the shared schedule are maintained by different project scheduling tools.

7. The system of claim 1, wherein visibility into the plurality of planned events impacting one or more of the plurality of portions are maintained by different entities of the plurality of entities on separate networks and by different types of tools.

8. The system of claim 1, wherein visibility into the plurality of planned events impacting one or more of the plurality of portions include a plurality of connected schedules.

9. The system of claim 8, wherein a detection of critical path between the plurality of connected schedules is created and maintained by different entities of the plurality of entities and different project scheduling tools.
